(19) United States
(12) Patent Application Publication
(10) Pub. No.: US 2019/0329505 A1
(43) Pub. Date: Oct. 31, 2019

(54) FOAM ADHERING DEVICE

(71) Applicants: SHENZHEN FUTAIHONG PRECISION INDUSTRY CO., LTD., Shenzhen (CN); FIH (HONG KONG) LIMITED, Kowloon (CN)

(72) Inventor: SHI-LONG GUO, Shenzhen (CN)

(21) Appl. No.: 15/993,716

(22) Filed: May 31, 2018

(30) Foreign Application Priority Data
Apr. 25, 2018 (CN) 201810378105.9

(51) Int. Cl. B29C 65/00; B21D 43/00; B29C 65/78

(52) U.S. Cl. CPC B29C 66/727; B25J 15/0028; B29C 65/7841; B21D 43/003

(57) ABSTRACT

A foam adhering device includes an adhering head, a camera module, and a rotating assembly. The camera module is located below the adhering head and configured to capture a position of foam adhered to the adhering head. The rotating assembly is configured to drive the adhering head to adjust a position of the adhering head according to the position of the foam adhered to the adhering head captured by the camera module. The rotating assembly includes a motor and a transmission assembly. The motor is configured to drive the transmission assembly, and the transmission assembly is coupled to the adhering head and configured to accurately/precisely adjust a position of the adhering head.

### FIELD

The subject matter herein generally relates to a device for adjusting a position of a foam piece.

### BACKGROUND

A foam adhering device is a high-accuracy adhering device including a tri-axial assembly. The foam adhering device positions a foam piece in position.

### BRIEF DESCRIPTION OF THE DRAWINGS

Implementations of the present disclosure will now be described, by way of example only, with reference to the attached figures.

FIG. 1 is an assembled, isometric view of an embodiment of a foam adhering device.

FIG. 2 is an isometric view of a rotating assembly of the foam adhering device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

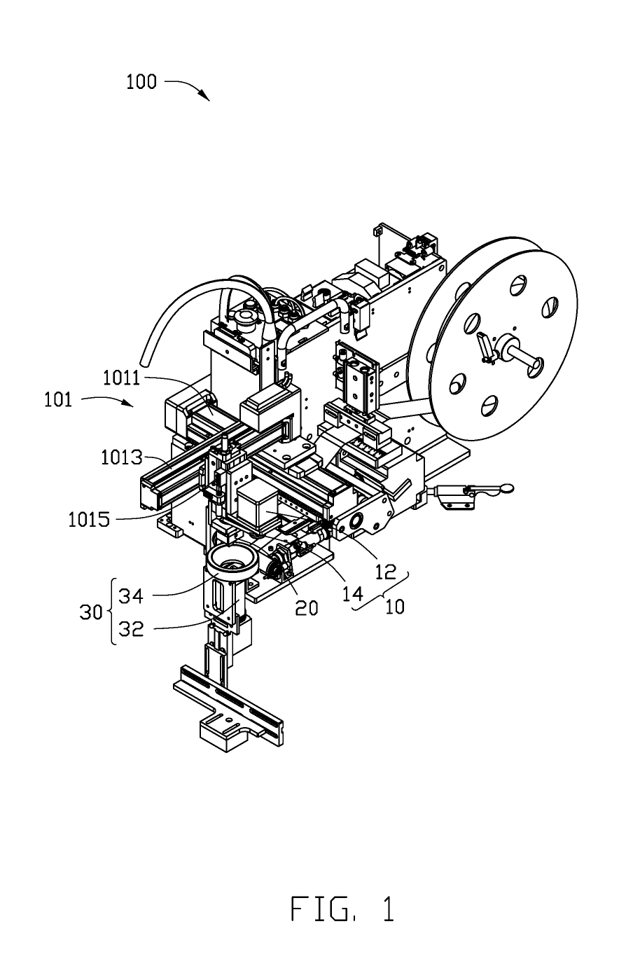

FIG. 1 illustrates an embodiment of a foam adhering device 100 (hereinafter “the device 100”). The device 100 includes a rotating assembly 10, an adhering head 20, and a camera module 30. The rotating assembly 10 includes a motor 12 and a transmission assembly 14. The motor 12 drives the transmission assembly 14, and the transmission assembly 14 is coupled to the adhering head 20. The transmission assembly 14 drives the adhering head 20 to allow adjusting a position of the adhering head 20. The camera module 30 is located under the adhering head 20 and captures an image of the position of foam adhered to the adhering head 20. The rotating assembly 10 drives the adhering head 20 according to the position of foam captured by the camera module 30 to adjust a position of the adhering head 20 to ensure accurate positioning of foam adhered to the adhering head 20. In detail, the transmission assembly 14 is coupled to the adhering head 20 along a direction of adhesion to the adhering head 20 (Z-axis direction). The transmission assembly 14 drives the adhering head 20 to adjust a position of the adhering head 20 along the Z-axis direction. The device 100 includes tri-axial assembly 101 including an X-axis rod 1011, a Y-axis rod 1013, and a Z-axis rod 1015. The Y-axis rod 1013 is installed along a horizontal direction on the X-axis rod 1011. The X-axis rod 1011 and the Y-axis rod 1013 are perpendicular to each other along a horizontal plane. The Z-axis rod 1015 is installed along a vertical direction on the Y-axis rod 1013. The Z-axis rod 1015 is perpendicular to the plane of the X-axis rod 1011 and the Y-axis rod 1013. The rotating assembly 10, the adhering head 20, and the camera module 30 are each installed along the Z-axis rod. Thus, a process of accurately positioning a foam piece is simplified.

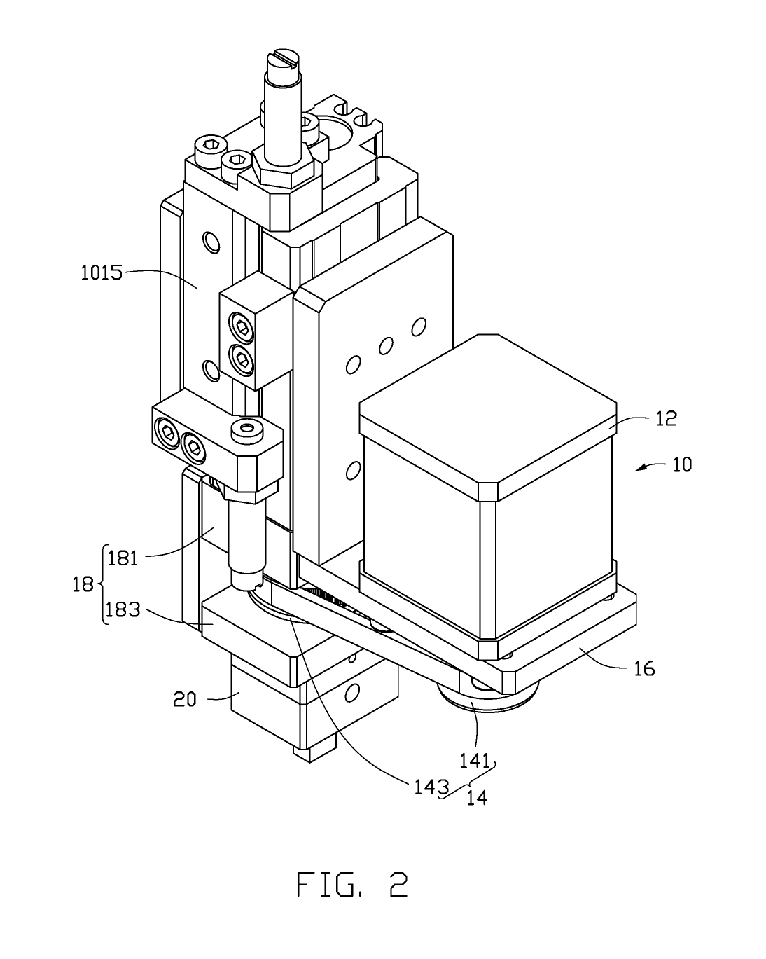

Referring to FIG. 2, the rotating assembly 10 includes a support frame 16 and a bearing assembly 18. The support frame 16 is located on a lateral side of an adhering direction of the adhering head 20. The bearing assembly 18 is located under the adhering direction of the adhering head 20. The motor 12 is located on the support frame 16. The transmission assembly 14 is located between the bearing assembly 18 and the support frame 16. In detail, the support frame 16 is located on an outer side of the Z-axis rod 1015. The bearing assembly 18 is located under the Z-axis rod 1015. Thus, the motor 12 and the transmission assembly 14 located on the support frame 16 and the bearing assembly 18 are operated along the Z-axis rod 1015. The transmission assembly 14 includes a belt pulley including a driving wheel 141 and a driven wheel 143. Alternatively, the transmission assembly 14 may comprise a chain/gear system (not shown). However, in the current embodiment, the driving wheel 141 is coupled to the motor 12. The driven wheel 143 is located on the bearing assembly 18 and is pivotably coupled to the adhering head 20. The motor 12 drives the driving wheel 141 to drive the driven wheel 143 to adjust the position of the adhering head 20. In at least one embodiment, the bearing assembly 18 includes a first bearing seat 181 and a second bearing seat 183. The first bearing seat 181 and the second bearing seat 183 each include a bearing (not shown in figures). The driven wheel 143 is located between the first bearing seat 181 and the second bearing seat 183. The driven wheel 143 is pivotably coupled to the adhering head 20 through the second bearing seat 183. Thus, the driven wheel 143 located between the first bearing seat 141 and the second bearing seat 143 can rotate steadily to precisely adjust the position of the adhering head 20.

Referring again to FIG. 1, the camera module 30 includes a lens 32 and a light source 34. The light source 34 is located under the adhering head 20. The lens 32 faces the adhering head 20 through the light source 34 to capture the position of the foam adhered to the adhering head 20. In at least one embodiment, the light source 34 is an annular light source surrounding the adhering head 20. The lens 32 faces the adhering head 20 through a center of the light source 34 to capture the position of foam adhered to the adhering head 20. In use, the camera module 30 located beneath the adhering head 20 (along the Z-direction) is able to capture clearly and accurately, through the light source 34, the position of foam adhered to the adhering head 20. Furthermore, by comparing the position of the foam to an adhering position, the rotating assembly 10 adjusts an angle of the adhering head 20 perpendicular to the plane of the X-axis rod 1011 and the Y-axis rod 1013. Thus, accuracy/precision of positioning the foam piece is increased, and the process of adjust the position of the foam piece is simplified.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A foam adhering device comprising:
an adhering head;
a camera module located below the adhering head and configured to capture a position of foam adhered to the adhering head; and
a rotating assembly configured to drive the adhering head to adjust a position of the adhering head according to the position of the foam adhered to the adhering head captured by the camera module,
wherein the rotating assembly comprises a motor and a transmission assembly, the motor is configured to drive the transmission assembly, and the transmission assembly is coupled to the adhering head and configured to adjust a position of the adhering head.

2. The foam adhering device of claim 1, wherein the transmission assembly of the rotating assembly is coupled to the adhering head along a vertical direction; and the transmission assembly drives the adhering head along a horizontal direction.

3. The foam adhering device of claim 2, wherein the rotating assembly further comprises a support frame and a bearing assembly; the support frame is located on a lateral side of an adhering direction of the adhering head; the bearing assembly is located under the adhering direction of the adhering head; the motor is located on the support frame; and the transmission assembly is located between the bearing assembly and the support frame.

4. The foam adhering device of claim 3, wherein the transmission assembly comprises a driving wheel and a driven wheel coupled as a belt pulley; the driving wheel is coupled to the motor located on the support frame; the driven wheel is located on the bearing assembly and is pivotably coupled to the adhering head; the motor drives the driving wheel to drive the driven wheel to adjust a position of the adhering head.

5. The foam adhering device of claim 4, wherein the bearing assembly comprises a first bearing seat and a second bearing seat; the driven wheel is located between the first bearing seat and the second bearing seat; the driven wheel is pivotably coupled to the adhering head through the second bearing seat.

6. The foam adhering device of claim 1, wherein the camera module comprises a lens and a light source; the light source is located below the adhering head; the lens faces the adhering head through the light source.

7. The foam adhering device of claim 6, wherein the light source is an annular light source surrounding the adhering head; the lens faces the adhering head through a center of the light source to capture the position of foam adhered to the adhering head.

8. The foam adhering device of claim 1, further comprising a tri-axial assembly comprising an X-axis rod, a Y-axis rod, and a Z-axis rod; wherein the Y-axis rod is installed along a horizontal direction on the X-axis rod; the X-axis rod and the Y-axis rod are perpendicular to each other along a horizontal plane; the Z-axis rod is installed along a vertical direction on the Y-axis rod; the Z-axis rod is perpendicular to the plane of the X-axis rod and the Y-axis rod; the rotating assembly, the adhering head, and the camera module are each installed along the Z-axis rod.
